(19) United States
(12) Patent Application Publication
(10) Pub. No.: US 2003/0234950 A1
(43) Pub. Date: Dec. 25, 2003

(54) Notification and adjustment of non-matching printers and printer drivers

(76) Inventor: Daniel Travis Lay, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/174,620

(22) Filed: Jun. 19, 2002

(51) Int. Cl. G06F 3/12; G06F 15/00; G06F 11/30; G06F 13/00; G06F 9/00

(52) U.S. Cl. 358/1.14; 358/1.15; 710/16; 709/327

(57) ABSTRACT

A system including a computer and printer notifies a user when there is a mismatch between the printer and the printer driver executing on the computer. The system allows a user to select an appropriate printer driver for configuring a print job so that the driver and the printer are compatible. Benefits of the disclosed system include a reduction in the amount of time and print materials that are otherwise wasted when a printer driver is inadvertently used to configure a print job for a non-matching printer.

### TECHNICAL FIELD

The present disclosure generally relates to printing, and more particularly, to notifying a user of a non-matching printer/driver combination and to adjusting the printer/driver combination for compatibility.

### BACKGROUND

Small businesses, such home businesses operating out of home offices often have limited budgets for materials such as computer systems. However, many small businesses also have a need to produce various types of printed documents. Therefore, computing systems in such work environments regularly include a single computer and multiple printers (sometimes from various printer manufacturers) that can be alternately coupled to the computer via a local or direct connection. The direct coupling of different printers to a single computer is typically achieved by manually plugging and unplugging a cable connection from the computer to the desired printer. In addition, a switch box might be employed between the computer and the multiple printers that allows a user to more easily switch among the available printers.

A problem that commonly occurs when printing documents in such a computing environment is that of configuring and sending a print job to a printer using a driver that does not match the printer being used. For example, a computer may include three printer drivers (e.g., driver #1, driver #2, and driver #3), executable to configure a print job for three respective printers (e.g., printer #1, printer #2, and printer #3). A user wanting to print a document to printer #3 may confirm that the computer is coupled to printer #3, but then inadvertently configure the print job using the wrong printer driver, such as driver #1. This might understandably occur where the computer's “default” driver is set to driver #1. Alternately, a user wanting to print a document to printer #1 may configure the print job using the default printer driver #1, but then forget that the computer is actually directly coupled to printer #3.

In both scenarios, there is a mismatch between the printer driver being used to configure the print job and the printer that is being used to render the print job. The result is that the printer outputs an unintended document that contains unintelligible garbage characters all over it. The user typically does not discover that a printer/driver compatibility problem exists until the document is removed from the output tray of the printer. In addition to the added costs for wasted printing materials (e.g., paper, toner, ink, etc.), this problem can be frustrating and detrimental for users who rely on timely and accurately printed documents.

This problem is alleviated in networked systems having multiple users that share multiple printers through a host server or print server. In such systems, mismatches do not occur between drivers and printers because print jobs are automatically routed to the correct printer based on the characteristics of the driver used to configure the print job. However, in many small businesses and office settings it is not feasible or cost-effective to develop and maintain even a small network of computers and printers.

Accordingly, the need exists for a way to provide a notification to warn users when a mismatch is encountered between a printer driver used to configure a print job and a printer being used to print the print job. In addition, a need exists for a way to adjust the printer/driver combination to make the printer and driver compatible and resolve the mismatch.

### SUMMARY

A system includes executable instructions on a computer that are configured to notify a user when a printer coupled to the computer is not compatible with a printer driver being used to configure a print job. The printer/driver combination is adjustable to resolve a mismatch and make the printer/driver combination compatible.

In a first embodiment, each of a plurality of printer drivers stored and executable on a computer include a notification module and a printer/driver compatibility list. The printer/driver compatibility list contains information indicating which printer or printers are compatible with the particular driver. When a printer driver is activated (typically by a user initiating a print command from within an application), the notification module is configured to communicate with a printer coupled to the computer. The notification module compares printer identification information received from the printer with the printer/driver compatibility list. If the printer identification information does not match up with any printer on the printer/driver compatibility list, the notification module notifies the user of a mismatch between the printer and the printer driver. The notification is displayed on the computer's view screen and may include options for how a user can proceed with a print job. For example, the user can select a different printer driver that matches the printer coupled to the computer so the print job will be appropriately configured for the printer. The user may also change which printer is coupled to the computer so that the printer matches the currently activated printer driver.

In a second embodiment, a plurality of printer drivers are stored and executable on a computer along with a printer/driver compatibility module. The compatibility module includes compatibility information indicating appropriate matches for various printers and printer drivers. When a user initiates a print command from within an application, the compatibility module is configured to send a request to the printer for a printer identification. The compatibility module compares the printer identification with the compatibility information in the compatibility module to determine whether the current printer driver is an appropriate match for the printer. If the current printer driver is not compatible with the printer, the compatibility module notifies the user of a mismatch between the printer and the current printer driver. The compatibility module also determines an appropriate printer driver that matches up with the printer. The compatibility module can be configured to automatically initiate the appropriate printer driver or present the user with the option to proceed with the appropriate driver.

### BRIEF DESCRIPTION OF THE DRAWINGS

The same reference numbers are used throughout the drawings to reference like components and features.

FIG. 1 illustrates a system environment that is suitable for providing notification and adjustment of non-matching printers and printer drivers.

FIG. 2 illustrates an additional system environment that is suitable for providing notification and adjustment of non-matching printers and printer drivers.

FIG. 3 is a block diagram illustrating in greater detail, a particular embodiment of a host computer device and a plurality of printers as might be implemented in the system environments of FIGS. 1 and 2.

FIG. 4 is a block diagram illustrating in greater detail, another embodiment of a host computer device and a plurality of printers as might be implemented in the system environments of FIGS. 1 and 2.

FIG. 5 is a flow diagram illustrating an example method for providing notification and adjustment of non-matching printers and printer drivers.

FIG. 6 is a flow diagram illustrating an alternate example method for providing notification and adjustment of non-matching printers and printer drivers.

### DETAILED DESCRIPTION

A system including a computer and printer notifies a user when there is a mismatch between the printer and the printer driver executing on the computer. The system allows a user to select an appropriate printer driver for configuring a print job so that the driver and the printer are compatible. Benefits of the disclosed system include a reduction in the amount of time and print materials that are otherwise wasted when a printer driver is inadvertently used to configure a print job for a non-matching printer.

Exemplary System Environment for Providing Notification and Adjustment of Non-Matching Printers and Printer Drivers

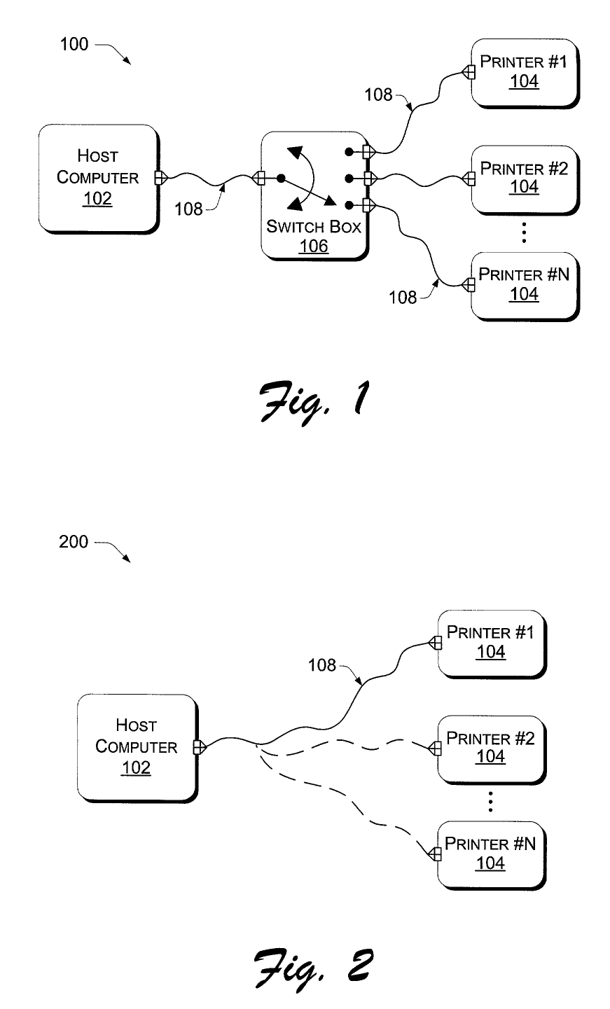

FIG. 1 illustrates an example of a system environment 100 suitable for providing a notification and adjustment of non-matching printers and printer drivers. The system 100 includes a host computer 102, one or more printer(s) 104 (i.e., printers #1, #2, through #N), and a switch box 106 operatively and directly coupling host computer 102 to one of the printer(s) 104 through direct local connectors 108. Switch box 106 and direct local connectors 108 provide alternate local connections between host computer 102 and any one of the printer(s) 104. Direct local connectors 108 typically include cables such as printer cables, but may also include any other suitable local and direct communication link. Switch box 106 is typically a manually operated device permitting a user to switch the host computer's 102 direct connection between any one of the printer(s) 104. However, one skilled in the art will readily recognize that various other switching mechanisms might be implemented in place of switch box 106 in order to perform the switching function of switch box 106.

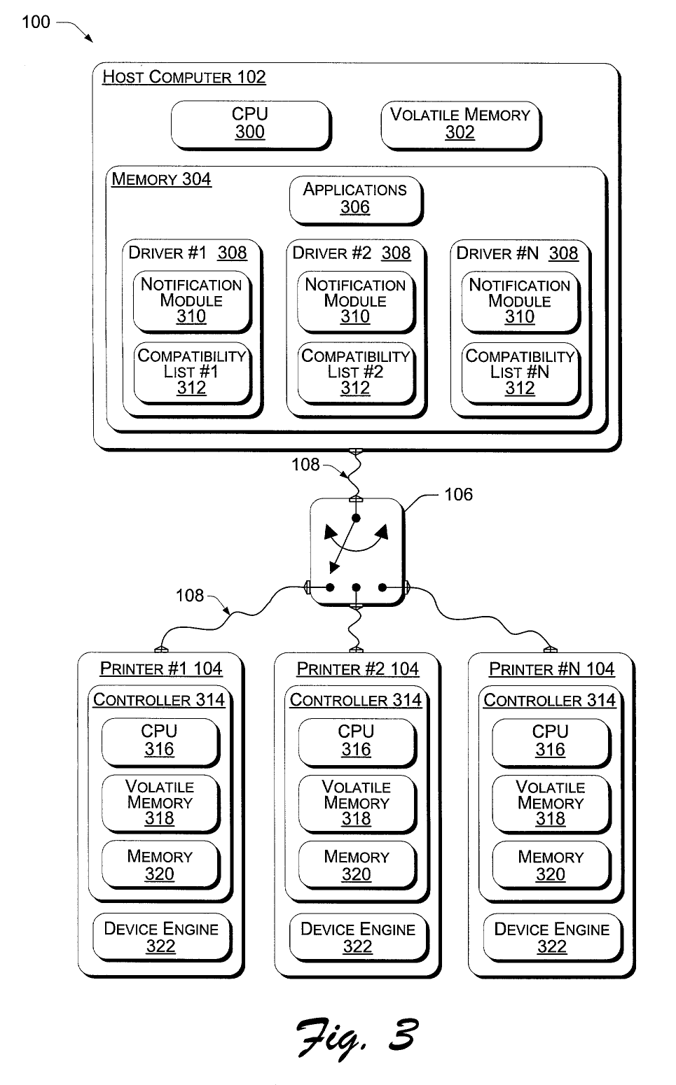

Moreover, switch box 106 may be removed altogether from the system environment 100 of FIG. 1, which then requires a completely manual coupling and uncoupling of host computer 102 to one of the printer(s) 104 through direct local connectors 108. Accordingly, FIG. 2 illustrates an alternate system environment 200 that is suitable for providing a notification and adjustment of non-matching printers and printer drivers. The system environment 200 of FIG. 2 includes host computer 102, one or more printer(s) 104, and direct local connector 108 (e.g., printer cable) for directly coupling host computer 102 alternately (as illustrated by the dashed lines) to one of the printer(s) 104.

Host computer 102 can be implemented as a variety of general purpose computing devices including, for example, a personal computer (PC), a laptop computer, a notebook computer, a handheld computing device, and other devices configured to communicate with printer(s) 104. Host computer 102 typically provides a user with the ability to manipulate or otherwise prepare in electronic form, an image or document to be rendered as an image that is printed or otherwise formed onto a print medium by printer(s) 104 after transmission over direct local connector(s) 108. In general, host computer 102 outputs host data to printer(s) 104 in a driver format (i.e., a page description language) suitable for the printer(s) 104, such as PCL or PostScript. Printer(s) 104 converts the host data and outputs it onto an appropriate recording media, such as paper or transparencies.

Printer(s) 104 includes various types of printing devices capable of rendering PDL (page description language) data in printed form on a print medium, such as printing pixels on paper. Therefore, printer(s) 104 can include devices such as laser-based printers, ink-based printers, plotters, multifunction peripheral devices and the like.

Exemplary System Embodiments for Providing Notification and Adjustment of Non-Matching Printers and Printer Drivers

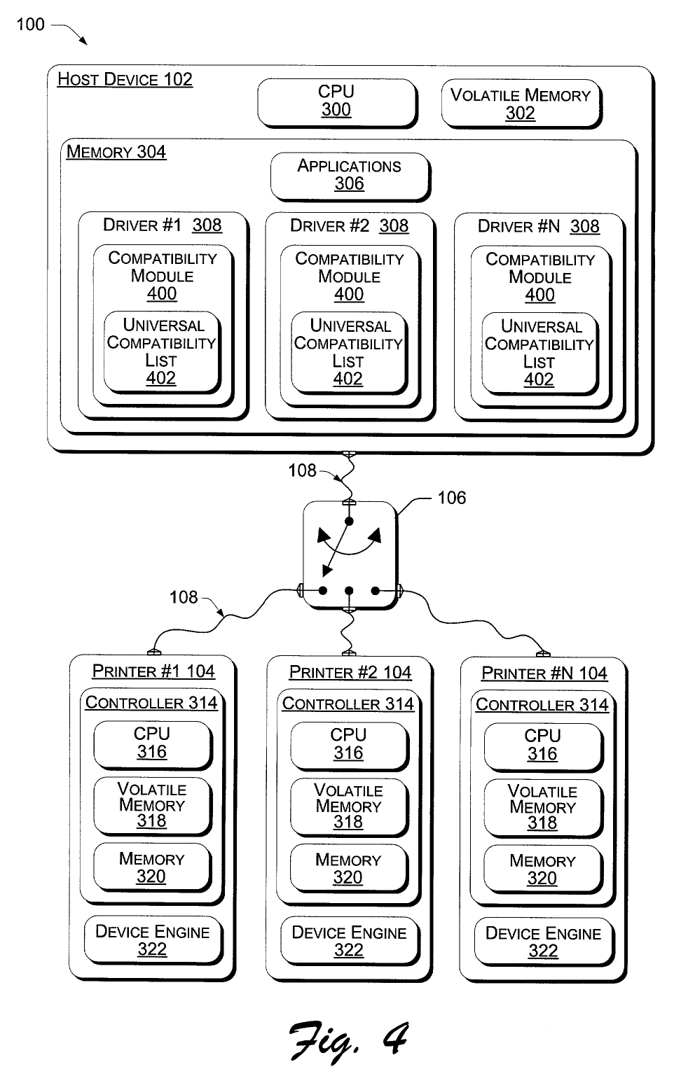

FIG. 3 is a block diagram illustrating in greater detail, a particular embodiment of a host computer 102 and printer(s) 104 as might be implemented in the system environments 100 and 200 of FIGS. 1 and 2 respectively. Host computer 102 typically includes a processor 300, a volatile memory 302 (i.e., RAM), and a nonvolatile memory 304 (e.g., ROM, hard disk, floppy disk, CD-ROM, etc.). Nonvolatile memory 304 generally provides storage of computer/processor-readable instructions, data structures, program modules and other data for host computer 102. Host computer 102 may implement various application programs 306 stored in memory 304 and executable on processor 300 that create a document or image (e.g., text and graphics) on a computer screen that is transferable to printer(s) 104 for creating a hard copy of the document/image. Such applications 306 might include software programs implementing, for example, word processors, spread sheets, browsers, multimedia players, illustrators, computer-aided design tools and the like.

Host computer 102 may also implement one or more software-based device drivers such as printer drivers #1, #2, through #N 308 that are stored in non-volatile memory 304 and executable on processor 300. In general, printer driver(s) 308 format document information into a page description language (PDL) such as PostScript or Printer Control Language (PCL) or another appropriate format which is output to a printer 104. In the current exemplary embodiment of FIG. 3, printer drivers #1, #2, through #N 308 correspond respectively to matching printers #1, #2, through #N 104. In addition, each of the printer drivers #1, #2, through #N 308 includes a notification module 310 and, respectively, a printer/driver compatibility list #1, #2, through #N 312. The notification module 310 and printer/driver compatibility list(s) 312 are generally configured to provide notification whenever a mismatch occurs between a printer driver 308 and a printer 104, as more fully discussed herein below. The notification module 310 and printer/driver compatibility list(s) 312 also provide for the adjustment of non-matching printers 104 and printer drivers 308.

Each printer 104 has a controller 314 that processes data from host computer 102. The controller 314 typically includes a data processing unit or CPU 316, a volatile memory 318 (i.e., RAM), and a nonvolatile memory 320. Nonvolatile memory 320 can include various computer storage media such as ROM, flash memory, a hard disk, a removable floppy disk, a removable optical disk and the like. Nonvolatile memory 320 generally provides storage of computer/processor-readable instructions, data structures, program modules and other data for printing device 102. Each printer 104 additionally includes a device engine 322 (i.e., print engine) that performs the actual printing of a document or forming of an image onto a print medium. The controller 314 generally processes image/document data from host computer 102 and manages printer 104 functions by controlling device engine 322.

As mentioned briefly above, the notification module 310 and printer/driver compatibility list 312 within each of the printer drivers 308 of host computer 102 are generally configured to provide notification and adjustment of non-matching printers 104 and printer drivers 308. Each printer/driver compatibility list #1, #2, through #N 312 contains a list of printers that are compatible with the respective printer drivers #1, #2, through #N 308. Referring to the FIG. 3 embodiment, the labeling of printer drivers 308 as printer driver #1, printer driver #2, and printer driver #N, and the corresponding labeling of printers 104 as printer #1, printer #2, and printer #N, is intended to indicate appropriate matches between compatible printer drivers 308 and printers 104. Therefore, the printer/driver compatibility list #1 312 in printer driver #1 308, for example, will include printer #1 104, because printer #1 104 is the printer that matches printer driver #1 308.

However, the printer/driver compatibility list #1 312 in printer driver #1 308 may also include other printers in addition to the matching printer #1 104. This is most likely to occur where the other printers are produced by the same manufacturer that produced printer #1 104. That is, it is unlikely that a printer driver (e.g., printer driver #1 308) designed by a manufacturer for use with a particular printer (e.g., printer #1 104) would be compatible for use with a printer (e.g., printer #2 104) produced by a different manufacturer. Therefore, it is possible that the printer/driver compatibility list #1 312 in printer driver #1 308 will only include matching printer #1 104, that the printer/driver compatibility list #2 312 in printer driver #2 308 will only include matching printer #2 104, and generally, that the printer/driver compatibility list #N 312 in printer driver #N 308 will only include matching printer #N 104.

The notification module 310 within each of the printer drivers 308 is configured to request and receive identification information from whichever printer 104 is coupled to host computer 102. This information transaction occurs as a bi-directional communication between the printer driver 308 and the printer 104. The bi-directional communication typically occurs when a printer driver 308 sends a print job to a printer 104, but may also occur at different times. For example, the bi-directional communication may occur upon the initiation of the printer driver 308. A printer driver 308 is typically initiated when a print command is activated from within an application program 306 executing on host computer 102. Therefore, the activation of a print command from within an application program 306 executing on host computer 102 initiates a printer driver 308 which causes notification module 310 to begin the bi-directional communication with the printer 104 currently coupled to host computer 102.

The notification module 310 is further configured to compare the printer identification information it receives from the printer with the compatibility list 312 in the active printer driver 308. For example, if printer driver #1 308 is the default driver on host computer 102, and a user activates a print command without altering the default driver, then printer driver #1 308 is the active printer driver whose compatibility list #1 312 is used to compare with the printer identification information. If the printer identification information matches up with a printer included in the printer driver #1 308 compatibility list #1 312 (i.e., indicating printer #1 104 is currently coupled to host computer 102), then there is no mismatch, and the printer driver #1 308 configures and sends the print job to the printer based on the print command.

If in the above scenario a different printer, such as printer #2 104, is coupled to host computer 102, the notification module 310 of printer driver #1 308 will compare identification information from printer #2 104 with the printer driver #1 308 compatibility list #2 312. This, of course, will result in a mismatch, because printer #2 104 does not appear in the printer driver #1 308 compatibility list #1 312. When the notification module 310 discovers such a mismatch, it notifies the user by displaying a printer/driver mismatch warning on the screen of host computer 102.

The printer/driver mismatch notification is a warning to a user that if the current print job is configured by the current printer driver #1 308 and rendered by the currently coupled printer #2 104, it will likely be output as an incoherent mess of garbled characters. Thus, the printer/driver mismatch notification permits a user to forego the current print process and select a different printer driver 308 (i.e., printer driver #2 308) with which to proceed. Alternatively, the user may uncouple the current printer #2 104 from host computer 102 (e.g., manually or via switch box 106) and couple the appropriately matched printer #1 104 that corresponds with the current printer driver #1 308.

In a particular instance of the current embodiment, in addition to displaying a printer/driver mismatch notification, the notification module 310 displays options for how to proceed with the current print job. These options assist the user in determining how to remedy the mismatch rather than leaving an inexperienced user wondering what to do next. The options may include, but are not limited to, canceling the print job, selecting a different printer driver 308 with which to configure the print job, and allowing the user to replace the currently coupled printer with a different printer prior to proceeding with rendering the current print job.

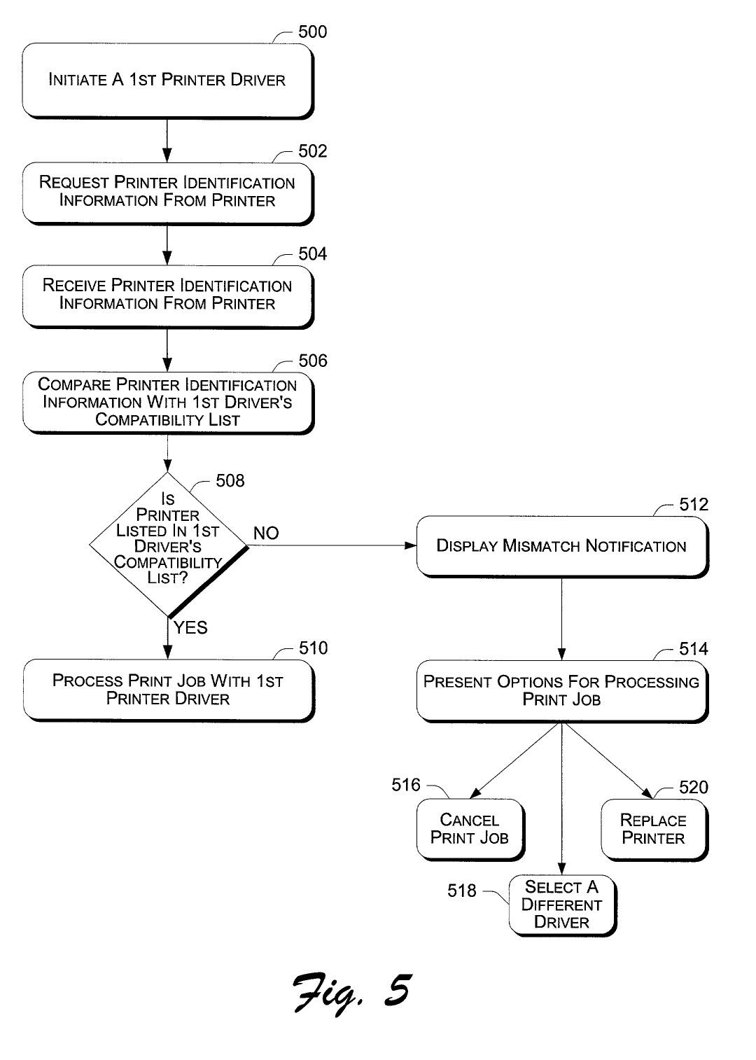

FIG. 4 is a block diagram illustrating in greater detail, an additional exemplary embodiment of a host computer 102 and printer(s) 104 as might be implemented in the system environments 100 and 200 of FIGS. 1 and 2 respectively. In the FIG. 4 embodiment, both the host computer 102 and printer(s) 104 are configured in the same manner as described above with respect to the FIG. 3 embodiment, except for some minor differences in the configuration of the printer drivers 308 on host computer 102. Rather than having a notification module 310 and separate compatibility lists #1, #2, through #N 312 specifically associated with respective printer drivers #1, #2, through #N 308, each printer driver #1, #2, through #N 308 has a compatibility module 400 containing a universal compatibility list 402.

The universal compatibility list 402 includes printer compatibility information for each of the printer drivers #1, #2, through #N 308. Therefore, universal compatibility list 402 includes each of the printer drivers #1, #2, through #N 308 along with those printers that are compatible with each printer driver #1, #2, through #N 308. For example, universal compatibility list 402 includes printer driver #1 308 and its associated compatible printer #1 104, printer driver #2 308 and its associated compatible printer #2 104, and generally, printer driver #N 308 and its associated compatible printer #N 104. As in the previously described embodiment of FIG. 3, there may be more than one compatible printer for any given printer driver.

Like the notification modules 308 of the FIG. 3 embodiment, the printer/driver compatibility modules 400 of FIG. 4 are configured to request and receive identification information from whichever printer 104 is coupled to host computer 102. As in the FIG. 3 embodiment, this information transaction takes place as a bidirectional communication that typically occurs when a printer driver 308 sends a print job to a printer 104 or upon the initiation of the printer driver 308, which can result from the activation of a print command within an application program 306 executing on host computer 102.

In a manner similar to the notification modules 308 of FIG. 3, the compatibility modules 400 of FIG. 4 are further configured to compare the printer identification information received from a printer 104 with the universal compatibility lists 402. If the printer identification information from the current printer 104 does not match up with the current printer driver 308, then the compatibility module 400 notifies the user by displaying a printer/driver mismatch notification on the screen of host computer 102. Thus, if printer driver #1 308 is the current or default driver on host computer 102, the printer identification information must indicate that printer #1 104 is the current printer in order for a match to occur. Otherwise, the comparison of the printer identification information with universal compatibility list 402 will indicate a mismatch between the printer driver and the printer. The compatibility module 400 would then display a mismatch notification on the screen of host computer 102. However, if the printer identification information indicates that printer #1 104 is the current printer, then there is a match between printer driver #1 308 and printer #1 104, and printer driver #1 308 proceeds with configuring and sending the print job to printer #1 104 for rendering.

When a mismatch exists between the printer driver 308 and the printer 104, the compatibility module 400 and universal compatibility list 402 of FIG. 4 provide additional functions. In addition to determining that the current printer 104 is not properly matched to the current printer driver 308 and displaying a mismatch notification, the compatibility module 400 continues comparing the printer identification information with the universal compatibility list 402 in order to determine which driver 308 is compatible with the current printer 104. Thus, if printer driver #1 308 is the current driver, and printer #2 104 is the current printer, the compatibility module 400 first determines that a mismatch exists, and then determines that the proper printer driver to match up with printer #2 104 is printer driver #2 308.

Then, in addition to displaying a mismatch notification on the screen of host computer 102, compatibility module 400 displays the appropriate printer driver (i.e., printer driver #2 308 in this instance) that it determines is the correct match for the currently connected printer #2 104. The compatibility module 400 further displays options for handling the mismatch which include, but are not limited to, canceling the print job, initiating the correctly matched printer driver (i.e., printer driver #2 308 in this instance) to proceed with configuring the print job, and allowing the user to replace the currently coupled printer with a different printer prior to proceeding with rendering the current print job. Furthermore, the compatibility module 400 is configurable to automatically initiate and proceed with whichever printer driver 308 is found to be the appropriately matched driver 308. Thus, rather than having to select an option of initiating the appropriately matched driver 308, a user can configure the compatibility module 400 to automatically initiate whichever driver it determines to be the appropriately matched driver 308. The appropriately matched driver 308 would then automatically proceed processing the print job.

Exemplary Methods for Providing Notification and Adjustment of Non-Matching Printers and Printer Drivers

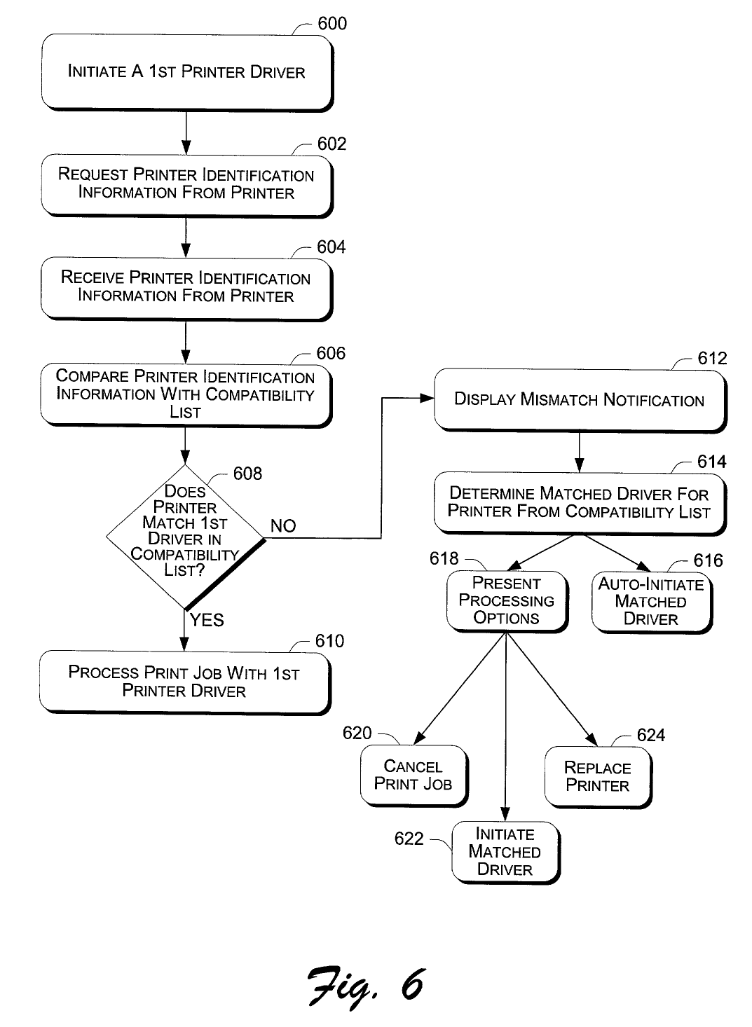

Example methods for providing notification and adjustment of non-matching printers and printer drivers will now be described with primary reference to the flow diagrams of FIGS. 5 and 6. The methods apply generally to the exemplary embodiments discussed above with respect to FIGS. 1-4. The elements of the described methods may be performed by any appropriate means, such as by the execution of processor-readable instructions defined on a processor-readable media, such as a disk, a ROM or other such memory device.

Referring to the method illustrated in FIG. 5, at block 500, a first printer driver is initiated. The first printer driver may be one of a number of executable drivers stored in a memory on a computer. At block 502, a request for identification information is made to a printer coupled to the computer. At block 504, printer identification information is received from the printer. At block 506, the printer identification information is compared with a compatibility list in the first printer driver. At block 508, a determination is made as to whether the printer is listed as a compatible printer in the first driver's compatibility list. If the printer is listed as a compatible printer in the first driver's compatibility list, then at block 510, a print job is processed with the first printer driver.

However, if the printer is not listed as a compatible printer in the first driver's compatibility list, then a mismatch notification is displayed at block 512. If a mismatch notification is displayed, options for processing a print job may also be displayed as shown in block 514. Several possible options include canceling the print job, selecting a different printer driver with which to process the print job, and replacing the printer with a different printer prior to processing the print job as shown in blocks 516, 518, and 520 respectively.

Referring now to the method illustrated in FIG. 6, at block 600, a first printer driver is initiated. The first printer driver may be one of a number of executable drivers stored in a memory on a computer. At block 602, a request for identification information is made to a printer coupled to the computer. At block 604, printer identification information is received from the printer. At block 606, the printer identification information is compared with a compatibility list. At block 608, a determination is made as to whether the printer matches up with the first printer driver in the compatibility list. If the printer matches up as being compatible with the first printer driver, then at block 610, a print job is processed with the first printer driver.

However, if the printer does not match up with the first printer driver, then a mismatch notification is displayed at block 612. In addition to displaying a mismatch notification, further comparison is made with the compatibility list to locate a driver that matches up with the printer, as shown in block 614. Once a matched driver is determined, the matched driver can be automatically initiated as shown in block 616, or options for processing a print job can be presented as shown in block 618. Several possible options include canceling the print job, initiating the matched printer driver to process the print job, and replacing the printer with a different printer prior to processing the print job as shown in blocks 620, 622, and 624 respectively.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
receiving identification information from a printer;
comparing the identification information to a printer compatibility list;
if the identification information matches a printer in the printer compatibility list, rendering a print job with the printer; and
if the identification information does not match a printer in the printer compatibility list, notifying a user of a mismatch.

2. A processor-readable medium as recited in claim 1, comprising further processor-executable instructions configured for initiating a printer driver, the printer driver including the printer compatibility list.

3. A processor-readable medium as recited in claim 1, wherein the rendering further comprises:
configuring the print job; and
sending the print job to the printer.

4. A processor-readable medium as recited in claim 1, wherein the notifying further comprises displaying a warning message on a computer screen.

5. A processor-readable medium as recited in claim 1, wherein the notifying further comprises presenting a user with options for processing the print job.

6. A processor-readable medium as recited in claim 5, wherein the options are selected from a group of options comprising:
canceling the print job;
selecting a different driver with which to configure the print job; and
replacing the printer with a different printer and rendering the print job with the different printer.

7. A processor-readable medium comprising processor-executable instructions configured for:
initiating a first printer driver to configure a print job;
receiving identification information from a printer;
comparing the identification information with a printer compatibility list in the first driver; and
displaying a mismatch notification based on the comparing.

8. A processor-readable medium as recited in claim 7, wherein the initiating further comprises:
receiving a print command from an application program executing on a computer; and
requesting the identification information from the printer.

9. A processor-readable medium as recited in claim 7, wherein the displaying further comprises presenting a user with options for proceeding with the print job.

10. A processor-readable medium as recited in claim 9, wherein the options are selected from a group of options comprising:
canceling the print job;
selecting a second driver with which to configure the print job; and
replacing the printer with a different printer and rendering the print job with the different printer.

11. A processor-readable medium as recited in claim 7, comprising further processor-executable instructions configured for:
based on the comparing, determining a second printer driver that is an appropriate match for the printer.

12. A processor-readable medium as recited in claim 11, comprising further processor-executable instructions configured for automatically initiating the second printer driver.

13. A processor-readable medium as recited in claim 11, comprising further processor-executable instructions configured for presenting a user with options for proceeding with the print job, the options selected from a group of options comprising:
canceling the print job;
initiating the second driver to configure the print job; and
replacing the printer with a different printer and rendering the print job with the different printer.

14. A processor-readable medium comprising processor-executable instructions configured for:
initiating a first printer driver;
receiving identification information from a printer;
comparing the identification information with a printer compatibility list in the first driver; and
based on the comparing, determining a second printer driver that is compatible with the printer.

15. A processor-readable medium as recited in claim 14, comprising further processor-executable instructions configured for automatically initiating the second printer driver.

16. A processor-readable medium as recited in claim 14, comprising further processor-executable instructions configured for:
based on the comparing, displaying a mismatch notification.

17. A processor-readable medium as recited in claim 14, comprising further processor-executable instructions configured for presenting a user with options for processing a print job, the options selected from a group of options comprising:
canceling the print job;
initiating the second driver to configure the print job; and
replacing the printer with a different printer and rendering the print job with the different printer.

18. A method for providing notification of a mismatch between a printer and a printer driver comprising:
initiating a printer driver, the printer driver including a printer compatibility list;
receiving identification information from a printer;
comparing the identification information to the printer compatibility list;
if the identification information matches a printer in the printer compatibility list, rendering a print job with the printer; and
if the identification information does not match a printer in the printer compatibility list, notifying a user of a mismatch.

19. A method for providing notification of a mismatch between a printer and a printer driver comprising:
initiating a first printer driver;
receiving identification information from a printer;
comparing the identification information with a printer compatibility list in the first driver; and
based on the comparing, determining a second printer driver that is compatible with the printer.

20. A method as recited in claim 19, further comprising automatically initiating the second printer driver.

21. A computer comprising:
a processor;
a memory; and
a printer driver stored in the memory and executable on the processor, the printer driver having a notification module configured for comparing a printer identification with a compatibility list to determine if there is a mismatch between the printer driver and a printer and for displaying a notification of the mismatch.

22. A computer comprising:
a processor;
a memory; and
a first printer driver stored in the memory and executable on the processor, the first printer driver having a compatibility module configured for determining a mismatch between the first printer driver and a printer, and for automatically initiating a second printer driver that is compatible with the printer.

23. A system comprising:
a computer;
a printer coupled to the computer; and
a printer driver having a notification module and a compatibility list, the notification module configured for comparing the printer to the compatibility list and notifying a user if there is a mismatch between the printer and the printer driver.

24. A system comprising:
a computer;
a printer coupled to the computer; and
a first printer driver having a compatibility module with a compatibility list, the compatibility module configured for determining a mismatch between the printer driver and the printer and for determining and initiating a second printer driver based on the mismatch.
